(19) United States
(12) Patent Application Publication
(10) Pub. No.: US 2020/0062058 A1
(43) Pub. Date: Feb. 27, 2020

(54) OFF-ROAD RECOVERY ANCHOR

(71) Applicant: DEADMAN, LLC, Escondido, CA (US)

(72) Inventors: Bryant WHITE, Escondido, CA (US); Daniel NORWOOD, Escondido, CA (US); Jason YOUNG, Valley Center, CA (US)

(73) Assignee: DEADMAN, LLC, Escondido, CA (US)

(21) Appl. No.: 16/610,889

(22) PCT Filed: May 4, 2018
(86) PCT No.: PCT/US2018/031246

§ 371 Date: Nov. 4, 2019

Related U.S. Application Data
(60) Provisional application No. 62/501,692, filed on May 4, 2017.

(51) Int. Cl. B60D 1/18; B60B 39/12

(52) U.S. Cl. CPC B60D 1/18; B60B 2900/731; B60B 2900/721; B60B 39/12

(57) ABSTRACT

Disclosed herein are recovery anchors comprising at least one sheet and at least one anchor line attached to the at least one sheet. Also disclosed are methods of releasing an immobilized vehicle using the disclosed recovery anchors.

### RELATED APPLICATIONS

The present application claims priority to the U.S. Provisional Application Ser. No. 62/501,692, filed on May 4, 2017 by White et al., and entitled “OFF-ROAD RECOVERY ANCHOR,” the entire disclosure of which is hereby incorporated by reference herein in its entirety, including the drawings.

### FIELD OF THE INVENTION

The present invention is in the field of equipment to assist with the recovery of a vehicle trapped in an off-road setting.

### BACKGROUND OF THE DISCLOSURE

Vehicles that travel over unpaved surfaces, for example “off-roading” vehicles, routinely encounter soft ground with a loose surface. Off-road areas typically include areas of sand, loose gravel, and mud. To navigate these surfaces successfully, off-roading vehicles exhibit high off the ground profiles to clear ground obstacles, large knobby tires for better traction over the loose surface, and 4×4 or all-wheel drives to distribute the engine power over all the wheels.

Despite these amenities, off-road vehicles frequently become stuck in the loose surface. At times, the immobility of the vehicle can potentially cause a dangerous situation as the off-road vehicles are in places far away from sources of help with little to no mobile phone services. Therefore, the operators of these vehicles must have proper equipment with them to independently free a stuck vehicle. While several devices and mechanisms to achieve this end are available on the market, they are cumbersome to use, require multiple individuals to set up and operate the device, and the results are at times unsatisfactory.

### SUMMARY OF THE INVENTION

Disclosed herein are recovery anchors comprising at least one sheet and at least one anchor line attached to the at least one sheet. Also disclosed are methods of releasing an immobilized vehicle using the disclosed recovery anchors.

### BRIEF DESCRIPTION OF THE DRAWINGS

FIG. 1 illustrates the basic design of one embodiment of the recovery anchors 100 disclosed herein.

FIG. 2A shows one embodiment of the configuration of the loops of the termini of the anchor line.

FIG. 2B illustrates the cross section of a terminus of the anchor line along the A-A line of FIG. 2A, depicting the location of the distal loops, and their configuration with respect to the anchor line and the contact area.

FIG. 3A shows the close up of one embodiment of the connection point between the anchor line and cross line.

FIG. 3B shows the cross section of the connection point of FIG. 3A.

### DETAILED DESCRIPTION OF THE EMBODIMENTS

Disclosed herein are simple recovery anchor devices for use in freeing an immobilized vehicle. The disclosed devices feature a simple yet elegant design that allow for a quick installation and simple use, which invariably afford the desired results.

Thus in the first aspect, disclosed herein are recovery anchors that comprise at least one sheet and at least one anchor lines attached to the sheet. The sheet is designed to either be buried in the ground or wrapped around a rock or boulder to provide proper anchoring of the device. The lines connect the sheet to the immobilized vehicle and provide the necessary pull to free the immobilized vehicle.

By “immobilized vehicle” throughout this disclosure it is meant a vehicle that is unable to move due to the wheels not being able to obtain traction or something other than the wheels of the vehicle are making contact with the ground. For example, a vehicle that is, or its wheels are, partially buried in sand or loose dirt; a vehicle that cannot obtain traction on loose dirt, gravel, or mud; a vehicle that is stuck in a rock crag or in the space between two rocks; and the like.

The disclosed recovery anchors will now be described in view of the accompanying drawings.

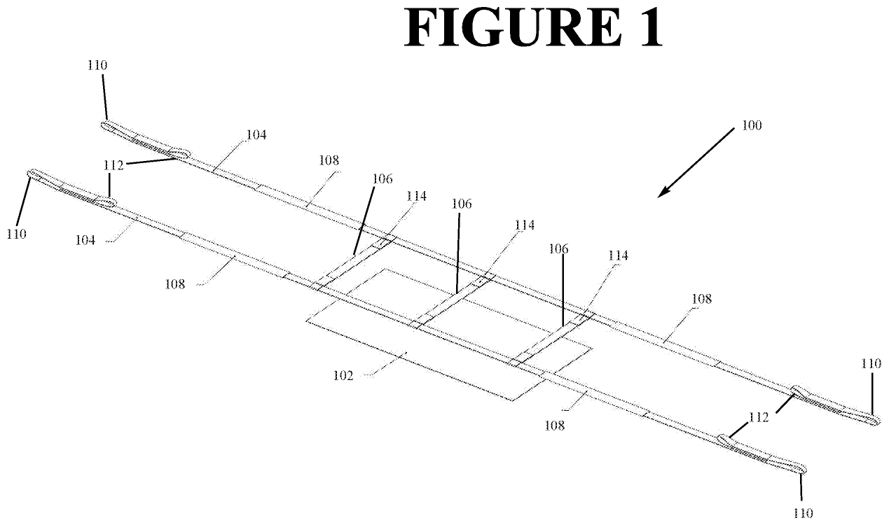

FIG. 1 illustrates the basic design of one embodiment of the recovery anchors 100 disclosed herein. The anchor 100 comprises at least one sheet 102 and at least one anchor line 104. For illustration and clarity purposes only, in FIG. 1 the sheet 102 is depicted as being separate from the anchor lines 104. The skilled artisan recognizes that the sheet 102 is strongly affixed to the anchor lines 104. By “strongly affixed” it is meant that the connection between the sheet 102 and the anchor lines 104 withstand the force imposed on them when pulling a car out of loose ground.

The sheet 102 can be made of any material that is strong enough for its purpose. These materials include, but are not limited to, tarp, mesh, canvas, burlap, hemp, nylon, polyester, plastic, or any other substance capable of holding soil under load or withstanding the requisite force to pull a car.

In some embodiments, such as the one shown in FIG. 1, the sheet is in the shape of a rectangle. In other embodiments, the sheet has another proper geometrical shape, for example, square, circle, oval, rectangle, rhombus, parallelogram and the like, while in yet other embodiments, the shape of the sheet is not that of a proper geometrical shape.

While in the embodiment shown in FIG. 1, the anchor 100 comprises only one sheet 102, in some embodiments, the anchor 100 comprises two or more sheets 102. In some embodiments, the multiple sheets 102 are contiguously connected, while in other embodiments, there are gaps of empty space in between the two or more sheets 102. In some embodiments where the anchor 100 comprises two or more sheets 102, the sheets are made up of the same material, while in other embodiments, the sheets are made up of different materials. Having sheets of different materials allows the user, or the manufacturer, to place a proper sheet at a proper location (e.g., in the middle or at the edges) for maximum efficacy of use.

In some embodiments, the anchor 100 simply has one anchor line 104. The embodiment shown in FIG. 1, illustrates two anchor lines 104, each running parallel to and flush with a long side of the rectangular sheet 102. The ordinary artisan recognizes that the line(s) 104 can be attached in any configuration to the sheet 102 that permits the function of the anchor 100 as described herein. Other embodiments include those in which the anchor 100 comprises 3, 4, 5, or more anchor lines 104.

In some embodiments where there are more than one anchor lines 104, one or more cross lines 106 connect the two or more anchor lines 104 together. The cross lines 106 provide strength and stability to the anchor 100. In some embodiments, the cross lines 106 serve to hold the anchor lines 104 in the proper orientation for maximum efficacy. Under certain conditions, in the absence of the cross lines 106, the anchor lines 104 can separate under load and point in different directions, thus lowering the effective direction and size of the force vector applied on the immobilized vehicle.

In some embodiments, the sheet 102 is affixed to anchor line 104 only. In other embodiments, the sheet 102 is affixed to cross line 106 only. In still other embodiments, the sheet 102 is affixed to both anchor lines 104 and cross lines 106.

In some embodiments, the anchor lines 104 have the same width, thickness, or diameter. In other embodiments, each anchor lines 104 independently has a fixed width, thickness, or diameter. In certain embodiments, the width, thickness, or diameter of the anchor lines 104 varies along the length of the anchor line 104.

In some embodiments, the cross lines 106 have the same width, thickness, or diameter. In other embodiments, each cross line 106 independently has a fixed width, thickness, or diameter. In certain embodiments, the width, thickness, or diameter of the cross lines 106 varies along the length of the cross line 106.

In some embodiments, each anchor line 104 comprises at least one rock sleeve 108. The rock sleeve 108 is tubular and it can slide over the anchor line 104. In the embodiment shown in FIG. 1, each anchor line 104 comprises two rock sleeves 108, each between a terminus of the anchor line 104 and the closest cross line 106 attachment point to the anchor line 104. During use, the rock sleeve 104 is placed where the anchor line 104 has the greatest pressure point of contact with a rock or any other hard object being used to anchor the anchor 100. The rock sleeve 108 provides a greater degree of strength in these areas and prevents the anchor line 104 to rub against a rock, and fray or weaken. In some embodiments, the rock sleeves 108 are replaceable and can be swapped out with a new one if the operator notices any weaknesses in the integrity of the rock sleeve 108. In other embodiments, the anchor 100 comprises no rock sleeve 108.

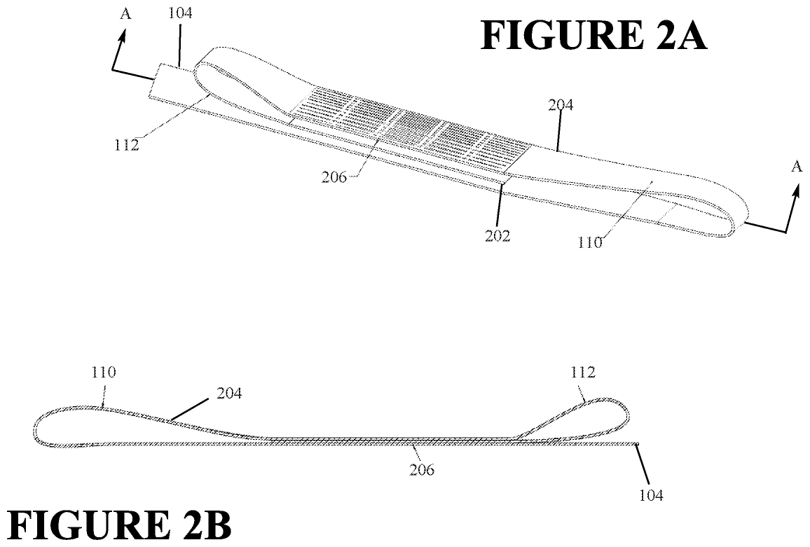

In some embodiments, each terminus of the anchor line 104 is folded upon itself to form a distal loop 110. The distal loop 110 is used to connect the anchor 100 to a hook, carabiner, ring, or any other device that connects the anchor 100 to an immobilized vehicle, or connects the distal loop 110 to other loops. In some embodiments, for example those shown in FIGS. 1, 2A & 2B, the terminus of the anchor line 104 is folded back twice to form two separate loops. Distal loop 110 is distal to the sheet 102, whereas proximal loop 112 is proximal to the sheet 102.

In certain embodiments, distal loop 110 and/or proximal loop 112 are made separately and then are affixed to their respective anchor line 104. In some embodiments, each anchor line 104 independently comprises a distal loop, or a proximal loop, or both a distal loop and a proximal loop.

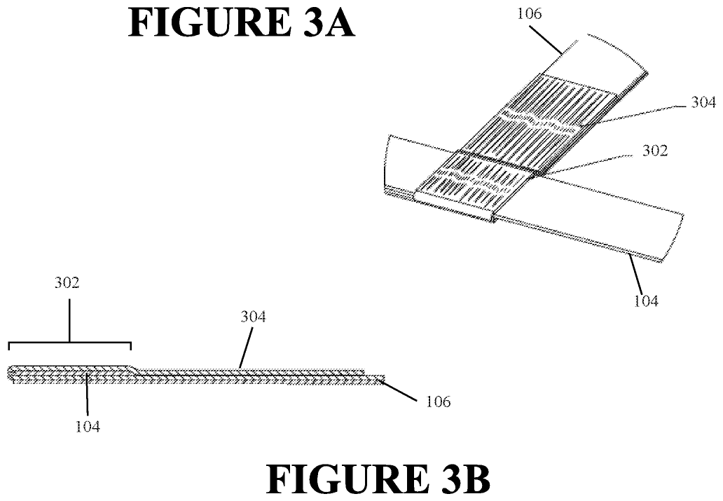

In some embodiments, each terminus 114 of the cross line 106 is affixed to an anchor line 104 such that the two termini 114 of the cross line 106 are affixed to different anchor lines 104. In certain embodiments, for example those shown in FIGS. 1, 3A & 3B, each terminus 114 of the cross line 106 is folded over the width of the anchor line 104 and is then affixed thereto. This arrangement provides much greater strength at the junction of the two lines 104 and 106.

FIG. 2A shows one embodiment of the configuration of the loops of the termini of the anchor line 104. The terminus 202 of the anchor line 104 is first folded back on itself to form distal loop 110. The portion 204 of the anchor line 104 that is folded back is once again folded in the direction of the main anchor line 104 to form proximal loop 112. In this configuration, the terminus 202 is placed between the anchor line 104 and the folded line 204. In another configuration (not shown), the folded line 204 is placed between the anchor line 104 and the terminus 202. In some embodiments, the contact area 206 is a section of the folded line 204 that overlaps the middle line (i.e., the section of the line that is folded between lines 104 and 204) and is between the terminus 202 and the proximal loop 112 (shaded area in FIG. 2A). In certain embodiments, the contact area 206 is further strengthened by the incorporation of additional material, such as more layers of the same material forming the anchor line 104, or one or more layers of another strong material. Further, in some embodiments, the contact area 206 is where the folded line 204 and the main anchor line 104 are affixed together.

FIG. 2B illustrates the cross section of a terminus of the anchor line 104 along the A-A line of FIG. 2A, depicting the location of distal loops 110 & 112, and their configuration with respect to the anchor line 104 and the contact area 206. Other configuration of the terminus of anchor line 104 known to an ordinary artisan that provide sufficient strength and hook up points (e.g., loops) to anchor an immobilized vehicle are also contemplated.

Each terminus of each cross line 106 is affixed to a part of the anchor line 104. In some embodiments, every cross line 106 is placed perpendicularly (i.e., at an angle between about 80° to about 100°) to each anchor line 104. In some embodiments, the terminus of the cross line 106 is placed over the anchor line 104 and affixed thereto. In other embodiments, the cross line 106 is folded over anchor line 104 and then, the folded portion of the cross line 106 is affixed to both the anchor line 104 and the main portion of the cross line 106.

By “about” a certain value it is meant that a range of value ±10%, and preferably a range of value ±5%, is contemplated. Thus, for example, having an angle of about 80° includes the angle range between 72° and 88°, and preferably between 76° and 84°. Furthermore, when about a range is given, it is understood that the word “about” qualifies both termini of the range. Thus, for example “about 7-10” means “about 7 to about 10.”

FIG. 3A shows the close up of one embodiment of the connection point 302 between the anchor line 104 and cross line 106. FIG. 3B shows the cross section of the connection point. In these embodiments, the cross line 106 is placed perpendicularly under or over the anchor line 104 such that a portion of the cross line 106 extends beyond the anchor line 104. The extended portion is then folded back over the cross line 106. The folded cross line 304 (shaded area FIG. 3A) covers the width of the anchor line 104 at the connection point 302, while also covering part of the length of the main cross line 106. The folded cross line 304 is then affixed to both the width of the anchor line 104 and the main cross line 106.

In some embodiments, each of the anchor lines 104 and cross lines 106 is independently made of a material that may include, but is not limited to, wire, rope (cotton, polymer, hemp, and the like), webbing, cable, or chain. In some embodiments, all anchor lines 104 and cross lines 106 are made up of the same material. In other embodiments, the anchor lines 104 and cross lines 106 are each independently up of a different material. In certain embodiments, one or more anchor line 104, or one or more cross line 106, comprises sections of different materials contiguously connected to each other.

It has been stated above that certain lines are affixed to other lines or the folded portion of a line, or that the sheet 102 is affixed to a line. There are several ways by which the ordinary artisan can affix the lines of the presently described anchor 100 can be affixed to other lines. For example, at each point of contact, the lines are affixed by a process selected from gluing, stitching, co-enmeshing, melting together, wrapping, and the like. Other methods of connecting known to the ordinary artisan are also contemplated. It is also noted that the sheet 102 is also affixed to the anchor line 104 by similar methods.

While there are many ways of affixing the lines together, the final product must satisfy certain criteria. For example, after affixing, the anchor 100 in its entirety must have the strength, both along the lines and at points of contact, to hold while an immobilized vehicle is being pulled. Also, except for the rock sleeve 108 and other similar accessories, the lines must not slide with respect to one another at the points of contact.

The anchor 100 is contemplated to be used to free an immobilized vehicle. Thus, in another aspect, disclosed herein are methods of releasing an immobilized vehicle using the anchor 100, the method comprising the steps of immobilizing the sheet 102, connecting proximal loops 112 together, connecting distal loops 110 to a pulling device, and pull the immobilized vehicle with the pulling device.

By “pulling device” it is meant any device that can pull the immobilized vehicle out of the environment in which it is trapped. The pulling device, in essence, is placed in between the sheet 102 and the immobilized vehicle. In some embodiments, the pulling device is connected by a link to the immobilized vehicle, while in other embodiments, the pulling device is connected by a link to the sheet 102. By “link” it is meant any line connecting the pulling device to the sheet 102 or the immobilized vehicle. The line may be a cable, rope, chain, webbing, and the like. When the pulling device is in operation, the pulling device pulls in the link to shorten its length.

In some embodiments, the pulling device is stationary with respect to the immobilized vehicle but in motion with respect to the sheet 102 when the pulling device is in operation, i.e., it is pulling. In other embodiments, the pulling device is stationary with respect to the sheet 102 but in motion with respect to the immobilized vehicle when the pulling device is in operation. In some embodiments, the pulling device is a winch, whether manual, electric, or otherwise motorized. In some embodiments, the winch is connected to the front or back of the immobilized vehicle, while in other embodiments, the winch is immobilized on the ground between the sheet 102 and the immobilized vehicle. In certain embodiments, the pulling device is another vehicle.

In some embodiments, the sheet 102 is immobilized by wrapping the sheet 102 around an immobilized object, for example a tree, a boulder, a rock, a column, and the like. In other embodiments, the sheet 102 is immobilized by burying it in the ground. In these embodiments, the anchor lines 104 poke out of the ground such that distal loops 110 and proximal loops 112 are visible above ground. In these embodiments, the weight of the earth over the sheet 102 exerts sufficient pressure on sheet 102 such that sheet 102 remains immobilized during the operation of the anchor 100.

In other embodiments, the sheet 102 is immobilized by wrapping it at the distal end, i.e., the end away from the immobilized vehicle, of a second vehicle. The sheet 102 may be spread around the grille, hood, bumper, back end, or the like, of the second vehicle. The second vehicle then moves away from the immobilized vehicle, thereby providing the force required for its release.

By “immobilized,” in reference to the object or sheet 102, above, and in references other than to an “immobilized vehicle,” it is meant that the object and the sheet 102 move insubstantially with respect to each other during the operation of the anchor 100. The object and the sheet 102 move insubstantially with respect to each other when the movement of the object or sheet 102 with respect to the other does not interfere with releasing the immobilized vehicle.

What is claimed is:

1. A recovery anchor comprising at least one sheet and at least one anchor line attached to the at least one sheet.

2. The recovery anchor of claim 1, wherein the recovery anchor comprises more than one anchor lines, and wherein the recovery anchor further comprises at least one cross line, wherein the at least one cross line connects the more than one anchor lines together.

3. The recovery anchor of claim 2, wherein the at least one anchor line connects the at least one sheet to an immobilized vehicle.

4. The recovery anchor of claim 2, wherein anchor line further comprises at least one rock sleeve.

5. The recovery anchor of claim 2, wherein each of the at least one anchor line further comprises a proximal loop, or a distal loop, or both a distal loop and a proximal loop.

6. The recovery anchor of claim 2, wherein each terminus of the at least one cross line is affixed to an anchor line such that the two termini of the cross line are affixed to different anchor lines.

7. The recovery anchor of claim 2, wherein each terminus of the at least one cross line is folded over the width of an anchor line and is then affixed thereto.

8. The recovery anchor of claim 2, wherein each of the at least one cross line is placed at an angle of between about 80° to about 100° to each anchor line.

9. A method of releasing an immobilized vehicle, the method comprising:
obtaining a recovery anchor, wherein the recovery anchor comprises at least one sheet and two or more anchor lines, wherein each anchor line comprises a proximal loop and a distal loop;
immobilizing the sheet with respect to an object;
connecting the proximal loop of one anchor line to the proximal loop of another anchor line;
connecting distal loop of one anchor line to the distal loop of another anchor line;
connecting the connected distal loops to a pulling device, and
pull the vehicle with the pulling device.

10. The method of claim 9, wherein the sheet is immobilized with respect to the object by wrapping the sheet around the object.

11. The method of claim 9 wherein the object is selected from a tree, a boulder, a rock, a column, or a second vehicle.

11. The method of claim 9, wherein the object is an amount of dirt or rock and the sheet is immobilized by burying it in the ground.
